(19) United States
(12) Patent Application Publication
(10) Pub. No.: US 2006/0123001 A1
(43) Pub. Date: Jun. 8, 2006

(54) Systems and methods for selecting digital advertisements

(75) Inventor: David M. Burns, Holliston, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: COPERNIC TECHNOLOGIES, INC., Sainte-Foy (CA)

(21) Appl. No.: 11/272,026

(22) Filed: Nov. 9, 2005

Related U.S. Application Data
(63) Continuation-in-part of application No. 11/249,045, filed on Oct. 12, 2005.
(60) Provisional application No. 60/626,320, filed on Nov. 9, 2004.
(60) Provisional application No. 60/627,044, filed on Nov. 10, 2004.
(60) Provisional application No. 60/618,109, filed on Oct. 13, 2004.

(51) Int. Cl. G06F 17/30

(52) U.S. Cl. 707/6

(57) ABSTRACT

Described herein are methods and systems for choosing digital advertisements to send to a user's computer while protecting private information. When a user performs a search using a public site, the user's search information is stored in a database. The system builds a profile for the user based on the public search information, which can be used to select advertisements for delivery to a Web site accessed by the user. The system can also select advertisements based on information gleamed from a user's private (desktop) searches. For example, the system can use the content or category in which a user is searching to choose advertisements.

### CROSS-REFERENCE TO RELATED APPLICATIONS

This application claims priority to U.S. Provisional Patent Application Ser. No. 60/626,320, entitled “A System to Monetize Web Searches With No Associated Paid Advertising and to Monetize Generic Software Applications,” filed Nov. 9, 2004; and 60/627,044, entitled “A System to Monetize Web Searches With No Associated Paid Advertising and To Monetize Generic Software Applications,” filed Nov. 10, 2004; and is a Continuation-In-Part of U.S. application Ser. No. 11/249,045, entitled “Systems and Methods for Protecting Private Electronic Data,” filed Oct. 12, 2005, which claim priority to U.S. Provisional Patent Application Ser. No. 60/618,109, entitled “A System for Monetizing the Search of Private Desktop Content Based on Algorithmic Analysis of Public Web Search Terms,” all of which are hereby incorporated by reference in their entirety.

### BACKGROUND OF THE INVENTION

While users of web based search engines, such as Yahoo and Google, have come to expect free searching, there are significant cost associated with serving search results. Search portals must pay for thousands of servers, extensive storage, hosting, network bandwidth, and a variety of other associated costs. To offset these costs and to provide a stream of revenue, portals often send out what are commonly referred to as “ad links,” “sponsored links,” “paid links,” or “pay for performance links” (hereinafter referred “ad links”) along with their Web search results.

Advertisers purchase the right to show their ad links (and/or other digital ads) when a users types a predetermined keywords into a search engine. The leading vendors supplying these types of paid links are Google with their Ad Sense technology and Overture. There are also smaller companies that specialize in certain markets, such as FindWhat/Espotting who specialize in the European paid link market.

All of these conventional systems generally work in the same way. When a user types a keyword into a search engine, the keyword is sent simultaneously to the search provider and to the paid link provider. The search provider returns Web search results while the paid link provider returns some number of (e.g., three) paid ad links. When a user clicks on the ad links, the advertiser pays the search engine a predetermined amount of money per click.

In general, advertisers ate only interested paying for popular keywords. For example, the percentage of searches that have paid links associated with them is called the paid link providers “fill rate.” Fill rates from paid link providers such as Google and Overture typically run around 50%, meaning that approximately half of all searches have no paid links associated with them.

Advertisements also provide revenue streams for software companies that provide free or reduced cost programs in exchange for the right to show digital ads (link ads or otherwise). For example, a user can download a free program and install it on his or her computer, and while using the program, advertisements are displayed on part of the users screen. The user is provided with low cost software while the software developers are provided revenue from the advertisers. However, for this model to be successful, it is preferable to provide targeted ads.

As such, there currently exists a need to improve the effectiveness of digital advertisements both on the Web and/or in software, and preferably, to do so without violating a user's privacy.

### SUMMARY OF THE INVENTION

The invention meets the aforementioned objects, among others, by providing inter alia methods and systems for choosing digital advertisements to send to a user's computer, while protecting the user's private information.

Systems according to some such aspects of the invention distinguish between public search information (e.g., search terms used in a web based search engine) and private search information. Thus, in one aspect, such a system uses public search information to choose advertisements based on the relevancy, frequency, and/or affinity of public search terms. Private search information can also be used, however the system does not send private information across the world wide web. For example, instead of sending out private search terms, the system can select advertisements based on content, category, and/or distributor.

In a related aspect of the invention, a system according to the invention includes a user's computer (e.g., personal computer, laptop computer or other suitable digital data device) connected to the world wide web, a digital data sever connected to (i.e., in communication with) the user's computer through the world wide web, and an advertisement server. The user's computer is adapted to recognize and collect public search terms entered into a public search program through the user's computer. The digital data server is adapted to receive public search terms, and the advertisement server is adapted to choose and send ads based on the collected public search terms.

In one aspect, the user's computer includes a database that stores public search terms entered into a public search program. The database can also include date and/or time information that corresponds to the stored public search program. The system can use this information to rank the public search terms according to relevancy, frequency, and/or affinity and send the highest ranking search terms to the advertisement server. In addition, or alternatively, the database can contain information about the location at which the desktop search program was obtain.

In another aspect, the system can use the private search terms collected in the database to select advertisements. For example, the system can send content and/or category codes to the advertisements server. The advertisement server can then chose advertisements based on the category or content in which the user is searching. To assist with choosing advertisements, the advertisement server can include a database containing category codes and digital advertisements corresponding to the category codes.

In another aspect, a method for selecting digital advertisements, while privatizing personal information, is disclosed. The method includes the steps of collecting and storing, with a digital data processor, public search terms entered by a user into an internet based search program, and date and time information corresponding to the public search terms. The method can further include ranking the search terms according to relevancy, frequency, and/or affinity. Advertisements can be chosen based on the highest ranking search terms, and sent, with an advertisement server, to a Web site accessed by the user.

In one aspect, the served ads are “paid link” type ads associated with a Web based search program such as, for example, Google or Yahoo!. The system can use public search terms, search category, search content, and/or distribution information to choose the link ads. In particular, when a search term entered into a Web based search program does not have a link ad associated with the search term, the system described herein can choose a link ad based on a user profile built from public search terms.

### BRIEF DESCRIPTION OF THE DRAWINGS

The foregoing features, objects and advantages of the invention will become apparent to those skilled in the art from the following detailed description of a preferred embodiment, especially when considered in conjunction with the accompanying drawings.

FIG. 1 is a schematic diagram of one embodiment of the system described herein showing a user's computer connected, via the world wide web, to a digital data server and an advertisement server; and

FIG. 2 is a flow chart illustrating one embodiment of the algorithm used to select advertisements based on time behavior, recency, and/or frequency.

### DETAILED DESCRIPTION

Described herein are various methods and systems for choosing and serving digital advertisements (also referred to as “ads”) to Web sites and/or programs installed on a user's computer. In one aspect, such a system uses keyword information to choose advertisements based on the relevancy, frequency, and/or affinity of public keywords. Private keyword information can also be used, however the system preferably does not send private information across the world wide web. For example, instead of sending out private search terms, the system can match private search terms to category codes and send the category codes to an advertisement server.

In one embodiment, the system includes a user's computer (e.g., personal computer, laptop computer or other suitable digital data device) connected to the world wide web, a digital data sever connected to (i.e., in communication with) the user's computer through the world wide web, and an advertisement server. The user's computer is adapted to recognize and collect public keywords entered into a public Web sties through the user's computer. The digital data server is adapted to receive public keywords, and the advertisement server is adapted to choose and send ads based on the collected public keywords.

One skilled in the art will appreciate that the term “keyword” and “search term” can include the variety of words, numbers, and/or symbols entered into a Web based program. For example, “keywords” and “search terms” can include, by way of non-limiting example, terms entered into a Web based search engine, terms entered into a Web based dictionary or encyclopedia, and terms entered into a Web based store.

In addition to keywords entered into public Web sites, the system described herein can work with a local program, such as, for example a private desktop search program (e.g., Copernic Desktop Search (“CDS”)). Search terms entered into the desktop search program can also, or alternatively, be used to choose ads. In one embodiment, the database mentioned above can include a list of category codes that correspond to private search terms. In another aspect, content codes related to a type of program or file can be stored in the database. Content codes to be used to indicate what type of file a user is searching or what type of application a user has open (e.g., audio, video, and/or text based application). In yet another aspect, information related to the location at which the program was obtained (i.e., distribution information) can be stored in the database.

In one embodiment, the served ads are “paid link” type ads associated with a Web based search program such as, for example, Google or Yahoo!. For example, the system can use public search terms, category codes, content codes, and/or distribution information to choose the link ads for display on a Web site. In one aspect, the system is particularly useful for choosing link ads when a user enters a search term into a search engine that does not have a link ad associated with the entered search term. Instead of displaying a generic ad, the system can choose a targeted link ad based on information stored in a database on the user's computer.

While this system is described with respect to link ads and public Web search portals, one skilled in the art will appreciate that it could similarly be applied to any public or private Web site and/or to advertisements displayed in conjunction with software installed on a user's computer. For example, the system described herein can be used to choose ads for display on Web based dictionaries, encyclopedias, newspapers, scoreboards, auction sites, and the variety of Web pages that generate revenue based at least partially on ads. In addition to Web pages, the system can be used to deliver adds to the variety of program that are downloaded by users and which rely on add revenue. Rather than sending out generic ads to the download program, the system described here can be used to send targeted ads.

While information obtained from a private desktop search program can be helpful, it also raises the risks of privacy violations. As such, a Privacy First algorithm described herein distinguishes between public and private content. In particular, “private” content is described for the purposes of this document as data in which a user would have some expectation of privacy (i.e., it is password protected and/or stored on private computer/network). Examples might include, personal web pages, e-mails files, contact information, pictures, videos, music, internet search information (e.g., bookmarks, history and favorites) and other types of content searched by Copernic Desktop search systems. The system described herein is designed to guard the privacy of such private content by ensuring that keywords sent over the open Internet do not disclose such private content. For example, in one embodiment, keywords are not obtained by direct or indirect examination, or algorithmic analysis of, such private content.

It is generally agreed that the best and highest-quality ad that can be served to a user is an exact match keyword ad. This means that a user types words into a search bar and those words are immediately sent to an advertising system, which then sends back the most relevant ad possible, based on those keywords. However, this model can raise several privacy issues. First, where those search terms are used with a private search program such as CDS, it is preferable not to send such private search terms over the public Internet. Second, if we assume that e-mails represent a high percentage of all private content searches, and if we further assume that name searches represent a high percentage of all e-mail searches, then we must conclude that a large percentage of the overall searches of private desktop content will be relatively ambiguous from the perspective of the keyword advertising system. This simply means that e-mail name searches can be sent all day long to a keyword advertising system and never achieve satisfying and relevant advertising results.

In one embodiment, in order to overcome the privacy obstacles and limitations discussed above, the system described herein includes a new relevancy technology that guards the privacy of desktop search users. One of the innovations behind the system is a separation or “firewall” between terms used to search for private content, and terms sent out over the open Internet to fetch ads. The system does not send out private search terms. Instead, the system uses algorithmic analysis of a dynamic public Web search terms database to deliver personalized “area of interest” ads to users.

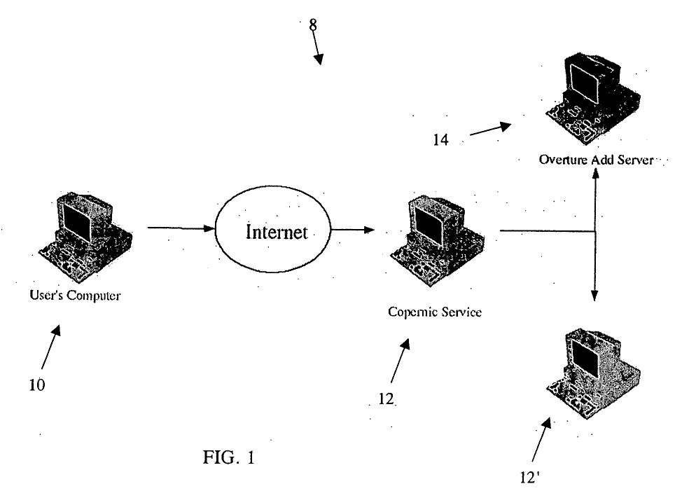

FIG. 1 illustrates one exemplary embodiment of system 8. As shown, a user's computer 10 can communicate with a digital data server 12 and/or an ad server 14. Based on a database of public search terms entered by the user, the system can rank the public search terms based on relevancy, frequency, and/or affinity. Choosen (e.g., highest ranked) public search terms can be sent to the ad server 14 and used to select ads for transmission to the user's computer 10 and/or to an additional data server 12′. Additionally or alternatively, as discussed below, other information such as category-type information and/or distribution information can be used to select ads.

In one aspect, server 12′ can be a public search engine. The ad sever can send. link ads (or other types of advertisements) to the server 12′ that are choosen based upon the information described above and below.

Users understand and have come to accept the fact that Web search terms entered into any major public search engine bar and subsequently sent out over the Internet to a Web or ad server have a high degree of public exposure, and in fact, have become virtual public information. Technically, from a purely quantitative perspective, this is true, as such Web search terms can be legally monitored by the ISP, and government agencies, and illegally monitored by any number of snoopers. However, it is also true from a qualitative perspective, as users will readily acknowledge that without knowing the exact details of the enabling technologies involved they believe that any such Web search terms might be viewed by other entities. While accepting as they may be about others viewing their public Web search terms, users are just the opposite, and are very emotional about the use of their private content. They believe that these private content search terms are secure on their PC, and must never be exposed to the public Internet in the same way in which their search terms of Web content are exposed during the Web search process.

At the same time, the new Privacy First system has fine tuned its approach to vertical ads. Distribution partners or syndicates of potential distribution partners will have the opportunity to come forward with targeted pay for performance advertising. Targeting can occur across multiple dimensions.

In one embodiment, advertisers may target based on content type, i.e. my web pages, files, e-mails, pictures, images, video, favorites, history, and contacts (e.g., the type of program rather than the private information stored in the program). Some of these content categories offer the opportunity for extremely vertically targeted ads, such as pictures, videos, music and contacts. Others such as e-mail and files are far more horizontal.

In another embodiment, advertisers can select ads based on a category. For example, if a user enters a search term into a private search program, the system can use a category associated with the search term to select an advertisement. For example, if the user searches for the name of a band, the category could be music.

Another way to target vertical advertising is by distribution partner. For example, each distribution partner can have an understanding of its own particular demographics. Users who download a version of Copernic Desktop Search from Best Buy may be interested in ads that are very different than users who download Copernic Desktop Search from portals or from a telco company such as Verizon. The new Privacy First system allows a distribution partner to select the logical flow of the advertising algorithm across each Copernic Desktop Search content type and/or distribution partner.

In yet another embodiment, public search terms are used to choose advertisement. In one aspect, the system include a database on the user's PC of public search terms that are sent out across public Web search engines over the public Internet from a user's computer. To that 100% of the content collected is comprised of public Web search terms. For example, Privacy First can restrict its tracking to a “white” list consisting of the top publicly acknowledged Web search engines. This keyword database, in one embodiment, is not sent out over the Internet or to any central location. It is only used by Privacy First relevancy algorithm to determine the best possible “area of interest” ad to be served to the user at any point in time.

When a user visits a public Web site and/or sends information to a public Web site (e.g., enters a search in a search engine), the system can look at a workflow database and determine whether to serve an ad. If an ad should be sent, an appropriate ad can be choosen based on, for example previously submitted public search terms, distribution source, and/or private search activities.

The Privacy First system can send to its central category ad server a secure coded distribution identification number indicating the distribution partner from which the user downloaded the particular version of CDS. This source may be Copernic.com, a portal, an e-commerce company, or if any one of Copernic's CDS distribution channel partners.

The system can also information related to public and/or private search activities. The information can be public search terms, content codes, and/or categories codes related to private search activities.

So for example, if a user gets his software from Best Buy, and searches for music (e.g., searches music-type files and/or the name of a band), Privacy First system can send two pieces of information to the ad server. For example, the Privacy First system can send out content and/or category=music (or the specific search term if the search is performed on a public search engine) and distributor=Best Buy. The CDS ad server will respond to this Privacy First information by sending a vertical category ad choosen by the distribution partner back to Web site the user is visiting. A specific example of user interaction might be that a user searches for the term Britney and receives an ad for a “buy one CD get one free” for the next week from Best Buy.

In an alternative embodiment, where the website is a public site, the public search term entered by the user (e.g., Britney) is sent to the ad server. The system could then choose to send an even more targeted add based on the particular musician. For example the system can use the search term Britney and/or the distribution partner to choose an ad.

In another embodiment, The Privacy First system can instead use dynamic and/or static techniques to choose the best possible public Web search terms at that moment in time, and sends that public keyword or set of keywords to the ad server.

Over time, the Privacy First public keyword database can collect a series of public search terms entered into public search engines. As the database grows, so does the ability of Privacy First to generate relevant ads based on the database. Privacy First automatically subjects the words in the keyword database to a number of algorithms, each of which generates some level of bonus score for every search term or phrase.

Recency is one of the Privacy First algorithms, and can be one of the most important. If a user has done a search for a particular term in the last few minutes (a public search), that term is assigned a higher recency score then the score used if the user has not searched for that term in more than an hour. Terms searched in the last hour are scored higher than terms searched in the last day, which are scored higher than terms searched in the last month, etc. The shape of the time versus bonus curve can be adjusted according to the needs of the user. In one embodiment, the curve non-linear and decays rapidly with time. Thus, the more recent the search term, the higher the recency bonus will be.

Another factor on which algorithms can be based is frequency. Simply put, frequency measures how often each term has been searched for, not taking into account how far back in time a particular term was searched for. Frequency is important because it indicates to Privacy First the level of interest in a particular term or area. Frequency and recency have an important interaction. It is quite possible that terms which are frequently searched for in the distant past are not very relevant to the user in the present. Examples of these types of terms are terms associated with a life event or societal events. If these events happened in the distant past, even though the search terms were very frequent, the recency algorithm would factor them down. If these events happened in the near past, and if the search terms were very frequent, then Privacy First must look to see if the frequency of such terms has fallen off dramatically. If it has, it might mean that the event itself has passed, and that the user is no longer interested in seeing ads associated with such search terms.

Another factor is Affinity. Affinity means that certain words or phrases are typically found in e-mails files or web pages containing the user's search terms. It would have been very easy for Privacy First to read through the users' e-mails, files, web pages, etc. in order to obtain such information. Products such as Blinkx, may be seen as abusing a user's privacy by performing this type of processing. For example, Blinkx will read user's e-mails and files and extract key terms and send those key terms from the user's private content over the public Internet in order to match those terms with appropriate web pages, from which keywords have been previously extracted. Conversely, Privacy First ensures that the user's private content is never read for the purposes of advertising, and that no keywords, phrases, or concepts are ever extracted from the user's private content for any purposes.

Due to its privacy constraints, the Privacy First relevancy algorithm takes a much different approach to affinity. Instead of reading users' private content or tracking what users type into the browser address bar (in a private search engine), or ads that they click, on Web search results that they click on, Privacy First can use a combination of many pieces of information that are available based strictly on the user's public Web search habits. For example, in our public Web search terms database, which reflects the user's Web search habits, we not only track search terms, but we also track the date, the day of the week, and the time of day the search occurred.

What is done with this information, and how it is used for the benefit of increasing relevancy can improve the Privacy First relevancy algorithm. For example, if a user is searching for the term “pizza” every night at 11 o'clock, then the system can provide a dynamic relevancy bonus to the term “pizza,” if the user is searching around that time. If certain search terms have historically corresponded to the time of year, for example, “skiing” in the winter and “beaches” in the summer, then again, the system can start to increase bonus amounts for those terms as that traditional time of year draws near. If certain search terms are usually searched for in the day, such as “stocks,” and certain search terms are searched for in the night, such as “sex,” then the system can bonus accordingly as these times approach. If certain search terms are typically searched for during the week, and others are searched for almost exclusively on weekends, the system can again make decisions through the allocation of bonus points on behalf of the user. The system can also measure the affinity of terms for other terms with respect to both recency and frequency. So for example, if the system see a correlation between the terms Lexis and BMW, then if the user starts to increase his searches of one term, we might award bonus points to the other term. As the number of search terms in the database increases, the system can be fine-tuned to deliver increased relevancy to the user.

The Privacy First relevancy algorithm can have knowledge as to which content category users are currently searching, and also, which categories they tend to search at different hours, days, months, etc. The information on content category behavior may be incorporated in an algorithmic fashion into the Privacy First relevancy algorithm and used to improve the selection of public Web search terms used to invoke advertising. In addition, the Privacy First central server will pre-process all Privacy First relevancy algorithm public term keyword requests and all requests for vertical content category ads. After pre-processing, such requests may then be sent to a third party ad server.

Since all ad requests, whether for public term keyword based ads or content category ads, can go through the Privacy First central server, the Privacy First system can develop over time, a detailed behavioral analysis pattern of individual users, or a group of users corresponding to a distribution source, or a group of geographic users, or of course, then entire CDS user base. It is important to note that the public term based behavioral information collected by Privacy First is the same information that is stored by any centralized ad vendor such as Google or Overture. By definition, any information stored about the search habits of a user, or a collection of users, will be based only on terms used to search the public Web, and not on terms used to search the private desktop.

There is no doubt that keyword search is the best experience for the user and the best experience for the vendor and the advertiser, since the ads returned by keywords are always the most relevant and therefore have the highest click through. However, in order to have keywords, searches should have a high percentage of keyword content associated with them. While this may be true with Web searches, pure keyword advertising has drawbacks. For example, link ads on search engines might only be associated with an ad 50% of the time. As such, when a search term is entered into a search engine (or any type of public Web site), and is not associated with a link ad (or any type of ad), the Privacy First system can provide targeted adds base on a user's past public and/or private search habits.

For example, let's take the user who has expressed, through public search terms, an interest in baseball, the stock market, and music. If we could watch this user during the day, we might see if searches of his private content reflect some of these areas of interest. Let's assume that he a public search engine for the term “David.” Are we can to assume that he's no longer interested in baseball, the stock market, or music?. We think not. And this is the fundamental decision behind the user behavioral analysis of the Privacy First relevancy algorithm. Our decision is to focus on the longer term areas of interest and behavioral preferences expressed by users as a result of their public Web searching and leverage that to display the most relevant ads possible. The fact that the ads are not displayed at the same time the user is searching for specific keywords does not diminish the relevancy of area of interest ads that are displayed to the user.

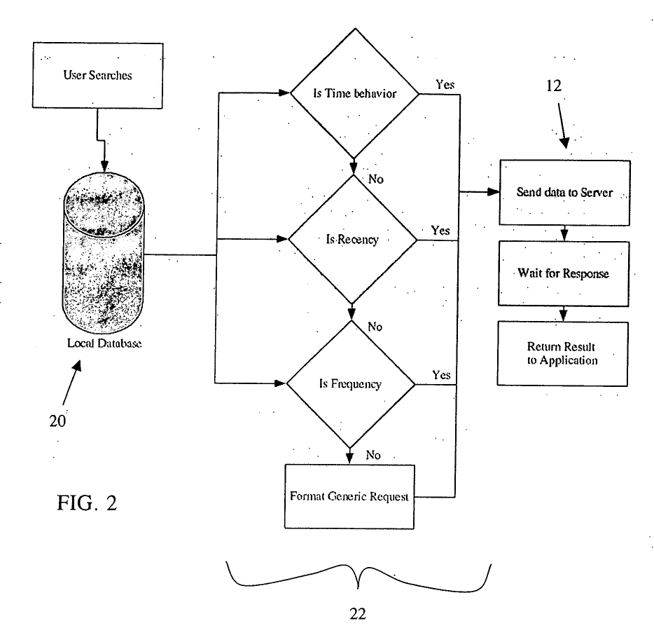

FIG. 2 illustrates a flow chart showing one embodiment of the algorithm used to select public search terms. As shown, user's search terms are stored in a database 20. The algorithm 22 then ranks and/or sorts the search terms according to time behavior, recency, and/or frequency. The highest ranking terms are sent to the digital data server 12 where the public search terms are used to select advertisements.

Hypothetical Case Studies

Our first case study is to examine a large telco or wireless company. For the purposes of our study, let's use AT&T wireless. AT&T wireless sells cell phones. Most of the sales are basic plans, say for example, $29.95 per month. Where AT&T makes all its money however, is on the high-margin items, for example cell phones which allow users to search the Internet, get e-mails, take and send images and videos, download music, etc. AT&T might therefore decide to use the system described herein to provide targeted ads. So for example, the user who has recently searched their email might see an ad for AT&T's e-mail phones. If the user clicks on images (on their desktop and/or on a Web site), the user might see an ad for AT&T's picture phones. Similarly, the video content/category can suggest ads for AT&T video capability and music searches can be related to ads for phones which have MP3 capability. If the user's contacts is open, or recently searched, the system might show phones which allow users to download their Outlook contacts. Both the web and my web pages categories could show phones which are Internet enabled. Other searching might not map well to AT&T's products. For these categories, AT&T might decide to fall back on information gathered from public searching, and if no results are available from the contracted ad server, to display a generic ad for the company or one of its products.

Our second case study involves a portal with many millions of users from all different backgrounds who are completely heterogeneous. This portal might decide to always use the Privacy First relevancy algorithm across all content categories, and never to use vertical ads. Or the portal might decide to first try Privacy First, and then fall back on vertical ads, which are reflections of its own advertisers. Of course as described above, the portal is then free to select ads which best fit the CDS content categories. The portal might also decide to have Privacy First relevancy algorithm ads in some categories, and content category ads in others.

The net result is that CDS with Privacy First offers our distribution partners a fresh, new, flexible, dynamic, and unique way of monetizing private content search traffic, keeping their brand in front of their users, and maintaining control of their own traffic. With its industry leading privacy policies, we are confident that customized, branded version of CDS will be viewed very favorably by our distribution partner's customers.

Local Relevancy Engine

The local relevancy engine is a system which allows the monetization of downloaded programs and/or Web sites while maintaining absolute privacy and security. It uses only information knowingly sent over the internet by the user. No other information is tracked or recorded. There is a strong separation between “public” terms and “private” terms. Public terms, as discussed, are terms which are already public, like search terms used in internet search engines. Private terms are anything that is used on the local desktop which has not been used publicly.

It should be noted that “what is” and “what is not” private is a matter of policy not technology. At the software level, the technology that allows one to get “public” information is the same as that used to get “private” information.

As a matter of policy “public” terms are atomic, that is that they should not be broken into smaller queries. For example “ford mustang GT” should not be reduced to “ford mustang” unless the user has already used the search term “ford mustang.” However, if the term “ford mustang” has been used as well as “ford mustang GT,” it is reasonable to use “ford mustang” when appropriate.

Most user's have habits, they look for places to eat around lunch time, they look at traffic reports around the time they go home, they look for things that interest them at night. These sorts of behaviors should show up under analysis of user search history. There should be sufficient information in the searching habits of the user that his or her needs can be anticipated. Using this habitual behavior, we can anticipate a subject in which the user will likely be interested.

Overview

The system will consist of two basic components: the desktop software and the server software. The desktop software will be designed in such a way that it can be customized for each client. The client will be able to define which algorithms are used to select relevant keywords and in what order they are executed. The server software will take the keywords sent from the desktop software.

Algorithms

The algorithms used to select relevant keywords vary based on behavioral circumstances. Each algorithm is a strategy that is used to map current user actions into past “public” information.

Behavioral Analysis

One of the more interesting algorithms is to track user's behavior. User's behavior in terms of day and time of which he or she does “public” things on the internet can be tracked. Based on the time and day that the user tends to search, it should be possible to anticipate relevant keywords based on search history.

It should be noted, with behavioral analysis, there may be enough information to anticipate the user without any action on their part. A news'ticker could select relevant information and keywords based solely on day, date, and time mapped into the user's history. Time of day, this can be used to find daily behaviors like lunch plans, movies, etc. Day of week, this can be used to find weekly behaviors like weather reports or hobbies, etc. Day of month, this can be used to find monthly behaviors like financial trends, etc. Month, this can be used to find seasonal behaviors like sports teams, taxes, etc.

Recency Analysis

Similar to behavioral analysis, recency analysis tracks the users search history and anticipates relevant keywords based on most recent searches. The most recent terms out weigh older terms. Terms age non-linearly, that is they decay along a curve which accelerates with age. The curve at which a term or set of terms decay is based on the frequency at which the terms is used. If a term or set of terms is used infrequently, but fairly regularly, it will decay at a much slower rate than terms which are typically used frequently and who's use changes suddenly.

Frequency Analysis

Similar to recency analysis, frequency analysis uses the most frequently searched terms to anticipate relevant keywords. The terms used most often out weigh terms less often. Terms age similarly to “Recency Analysis”

Term Affinity

One of the more esoteric techniques for finding keywords is to using keyword affinity. It works on the notion that the individual terms are connected. Using a good history of a user's public actions it is possible to extract “context” out of simple terms. By linking terms by their individual words and by their proximity to other terms. A person searching for lease information at the same time they are searching for automobiles, it is likely that a search for automobiles is a good opportunity to show lease information.

Product Branding

The desktop software is “branded” by the customer. Each customer will have their own brand code which will be communicated with each internet transaction and will be used to direct the best advertisements for 'the user as defined by the client.

The system can be built in two parts. The internet service server and the desktop software.

Internet Service:
Accepts keywords, brand codes, and other information from the client.
Where appropriate brand codes are used to direct the server
Each brand will have the option of having its own service script
Keywords that have been sent are matched against target keywords which have been either purchased by clients or passed on to third party advertisement add server
Add servers can be specified by client using an HTTP redirect
The output of the internet service is to be determined, it is likely XML to be parsed and displayed at the desktop level or rendered in HTML at the service.
The information sent to the server may be saved for further analysis.
The server may accept keywords from the desktop client software for ranking.

System

The server can be built around commodity x86 server hardware. It should be designed so that requests can be answered at a rate of 50 queries a second, giving each system a peak of 3000 queries a minute peak or 1 million queries a day assuming that most of the time it will not be operating near peak performance. (about ¼ peak performance)

The system, for example, can be a fast dual processor. Linux system using a PostgreSQL database, Apache web server, and the PHP scripting language. An alternate system would be Windows Server 2003, MSSQL database, IIS, and ASP scripting language.

The disk subsystem can be 10K RPM SCSI, but fast DMA/ATA drives may be acceptable. The system should have as much RAM as possible. The RAM and the fast disk I/O is for the database. If the database resides on a separate machine from the web servers, the web servers can have moderate disk I/O and RAM.

Scaling

Scaling the system is straight forward, using multiple web servers behind a load balancer like Alteon, Cisco Local Director, or even a Linux LVS system.

The challenge is scaling the database. This can be accomplished in a couple ways known to one skilled in the art. First, we operate on the assumption that the database usage is asymmetrical and heavily weighted toward reads, i.e. There are very many more queries than updates or inserts.

Depending on the implementation and load on the system, it is not clear how much work will be done in the database. It may be that a single database can handle multiple web servers, or it may happen that the database will be the bottle neck and scaling a database for each web server makes sense.

In either case, the database scaling will be done with a single master/multiple slaves. A single master database will accept all administrative data and will push that data out to the slaves. In the unlikely event that a web server has to write to the master, a separate connection to the master database will be created and the update/insert will happen there.

If web server to master database writes become frequent, the scaling strategy will fail. If logging to the database is required, then each slave can have its own log which can be aggregated as needed. If data needs to be updated and shared by the web servers we will need to seek alternate scaling methods like full clustering of the database.

Desktop Relevancy Software
The desktop software can be a set of dynamic libraries
The API can be simple and consist of a minimal number of functions
The desktop software can call an API to add terms and data to the system
Terms inserted into the system can be evaluated and given a rank
Public terms may be sent to the internet service to assign rank.
The rank can be considered later by the various algorithms during selection.
The desktop software can call an API to retrieve information from the relevancy system
The algorithms used and the order in which they are used can be defined by the client.
Starting with the first algorithm, each algorithm can be tried successively until one returns valid information in the form of a public term.
The public term will be sent to the internet service server along with the brand code, user ID, and method by which the public term was choosen
The result of the internet query can be passed back to the desktop software
If a term is sent to the server and the server returns no data, that term's rank can be reduced making it a less likely choice next time.
Each algorithm created for the relevancy system can be a self contained shared library.
All information collected by the system can be usable by all algorithm modules.

One skilled in'the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A system for choosing digital ads, comprising:
a user's computer connected to the world wide web, the user's computer adapted to recognize and collect public search terms entered into a public search program through the user's computer, the user's computer further comprising a database including the public search terms entered into the public search program;
a digital data server connected to the user's computer through the world wide web and adapted to communicate therewith, the digital data server adapted to receive public search terms from the database; and
an ad server in communication with the user's computer and adapted to choose and send ads to a website based on public search terms received by the digital data server.

2. The system of claim 1, wherein the database stores distribution information that includes the location from which the desktop search program was obtained by the user.

3. The system of claim 2, wherein the ad sever contains a database of distribution information and ads associated with the distribution location, such that the ad server can receive distribution information and choose an ad to send to the user based on the distribution information.

4. The system of claim 1, wherein the database contains information on the time of day at which the public search terms where entered into the public search program.

5. The system of claim 1, wherein the database includes private search terms entered into a desktop search program and category codes corresponding to private search terms.

6. The system of claim 1, wherein the database includes content codes corresponding to types of programs on a user's computer

7. The system of claim 1, wherein the digital data server and ad server are located in separate computers connected via the world wide web.

8. The system of claim 1, wherein the ad server includes a database containing content codes and digital ads corresponding to the content codes.

9. The system of claim 1, further comprising multiple user computers in communication with the ad server.

10. The system of claim 1, wherein the ads are in the form of link ads.

11. The system of claim 1, wherein the website is a search engine.

12. A method for selecting digital ads, comprising the steps of:
collecting and storing, with a digital data processor, public search terms entered by a user into an internet based search program and date and time information corresponding to the public search terms;
ranking the search terms according to relevancy, frequency, and/or affinity based on the collected information; and
sending advertisements, with an ad server, to website accessed by the user based on the ranked search terms.

13. The method of claim 12, further comprising the step of collecting and storing, in a computer database, private search terms entered by a user into a desktop search program.

14. The method of claim 13, further comprising the step of matching the private search terms to category codes and sending the matched category codes to the ad server.

15. The method of claim 12, further comprising the step of matching a type of program used by the user to a content code and sending the matched content code to the ad server.

16. The method of claim 12, further comprising the step of creating a user profile based on the public search terms and the corresponding date and time information.

17. The method of claim 16, further comprising sending ads to the user's computer based on the user profile.

18. A method for sending ads to a website accessed by a user's computer, comprising the steps of:
storing, in a computer database on a user's computer, public search terms entered by a user into an internet based search program and storing date and time information corresponding to the public search terms;
storing, in a second computer database that is in communication with a digital data server, a list of search terms and correspond link ads;
comparing a search term send from the user's computer with search terms stored in the second computer database; and
sending ads, with an ad server, to a search engine website.

19. The method of claim 18, further comprising the step of sending the distribution information to the ad server and the ad server choosing ads based on the distribution information.

20. The method of claim 18, further comprising the step of choosing the search term, sent from the user's computer to the digital data server, based on relevancy, frequency, and/or affinity.
